(19) United States
(12) Patent Application Publication
(10) Pub. No.: US 2007/0093972 A1
(43) Pub. Date: Apr. 26, 2007

(54) Treadwear indicator system

(75) Inventors: Tejas Bhupendra Desai, Troy, MI (US); Patricia Kachouh, Sterling Heights, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation

(21) Appl. No.: 11/487,656

(22) Filed: Jul. 17, 2006

Related U.S. Application Data
(60) Provisional application No. 60/729,786, filed on Oct. 24, 2005.

(51) Int. Cl. G06F 19/00

(52) U.S. Cl. 702/34

(57) ABSTRACT

A treadwear indicator system includes a processor having an algorithm that monitors various signals to determine the remaining treadwear of the tires. In one example, the treadwear algorithm is a function of pressure and temperature of the tire, mileage on the tire, G forces and load exerted on the tire, and other information. The information relating to a new tire can be input into the processor at the factory and/or by a tire installer when changing tires. An indication of the treadwear is output to a vehicle display, for example.

The application claims priority to U.S. Provisional Application No. 60/729,786 which was filed on Oct. 24, 2005.

### BACKGROUND OF THE INVENTION

Tire pressure monitoring systems have been mandated by the U.S. government. A typical tire pressure monitoring system 10 is shown in FIG. 1. Prior art systems include a processor 12 that receives pressure and temperature signals 14 and 16 associated with a tire 18 of a wheel unit.

Vehicles have become more sophisticated, and it has become increasingly desirable to monitor and provide feedback to the driver regarding the performance of various vehicle systems. In particular, it is desirable to provide more sophisticated monitoring of wear-or replacement-type items in the vehicle. For example, some vehicles now include engine oil life monitoring systems to indicate to the driver the remaining oil life before a required oil and filter change.

What is needed is a system and method capable of monitoring the tires for indicating to the driver, for example, miles remaining before a recommended tire replacement.

### SUMMARY OF THE INVENTION AND ADVANTAGES

A treadwear indicator system includes a processor having an algorithm that monitors various signals to determine the remaining treadwear of the tires. In one example, the treadwear algorithm is a function of pressure and temperature of the tire, mileage on the tire, G forces and load exerted on the tire, and other information. The information relating to a new tire can be input into the processor at the factory and/or by a tire installer when changing tires. An indication of the treadwear is output to a vehicle display, for example.

### BRIEF DESCRIPTION OF THE DRAWINGS

Other advantages of the present invention can be understood by reference to the following detailed description when considered in connection with the accompanying drawings wherein:

FIG. 1 is a schematic view of a prior art tire monitoring system.

FIG. 2 is a schematic view of an example embodiment of a treadwear indicator system.

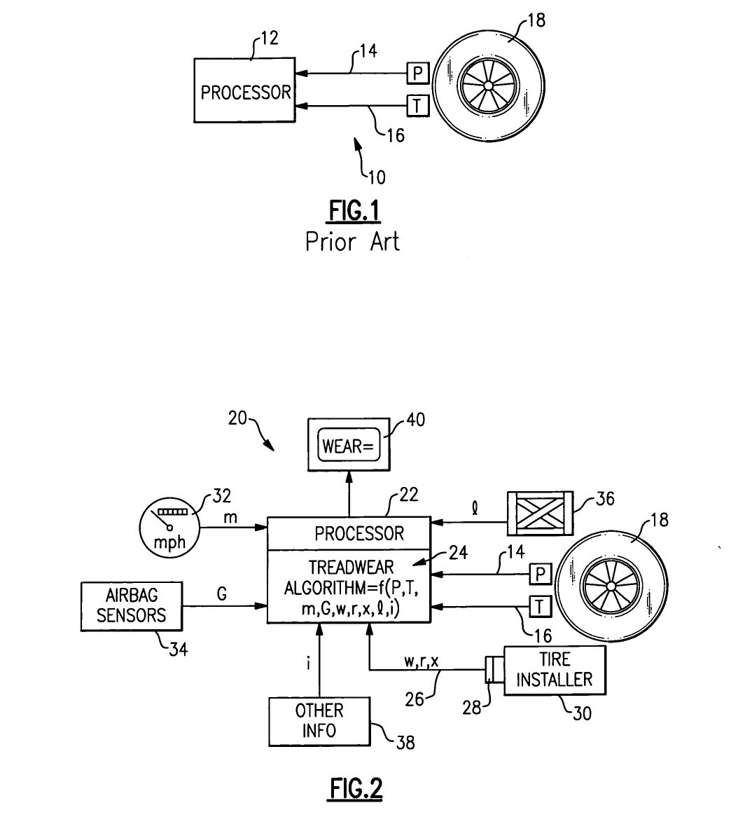

### DETAILED DESCRIPTION OF THE PREFERRED EMBODIMENT

An example embodiment of a treadwear indicator system 20 is shown in FIG. 2. The system 20 includes a processor 22, which can be a body control module of the vehicle. However, the processor 22 can be one or more processors that are integrated or separate but in communication with one another. Currently the body control module of the vehicle is used in some vehicle applications to monitor tire pressure. Accordingly, it may be desirable to use the body control module to monitor treadwear.

The processor 22 includes an algorithm 24 that receives the data relating to one or more tires of the vehicle's wheel units. The treadwear algorithm 24 is a function of numerous factors relating to the tire 18. In one example, the processor 22 receives pressure (P) and temperature (T) signals 14 and 16, which affect the treadwear. Additionally, tire information 26 relating to the particular tire in use is relevant, such as the tire's treadwear rating (w), temperature rating (r) and traction rating (x). The tire information 26 is initially input into the processor 22 by the vehicle manufacturer, in one example. Tire information relating to tires installed subsequently can be communicated by a device 30 used by the tire installer through a diagnostic link 28 that communicates with the processor 22, for example.

The treadwear algorithm 24 can also be a function of the mileage (m), which is communicated to the processor 22 from a mileage source 32. The G forces (G) on the tire 18 can also communicated to the processor 22 over a communications bus from an airbag sensor 34, for example. The load or weight (1) 36 placed on the tires 18 by the vehicle may also be input to the processor 22 as data for use by the algorithm 24. Additional information (i) can be sent from various other sources 38 to the processor 22. The treadwear algorithm can then output a treadwear indication, such as remaining wear in miles for one or more of the tires, to a device such as an in-vehicle display 40.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A treadwear indicator system comprising:
a processor receiving data, and including an algorithm using the data for determining treadwear; and
an output device for receiving an indication of the treadwear from the processor.

2. The system according to claim 1, wherein the data includes tire information comprising at least one of a tire treadwear rating, a tire temperature rating and a tire traction rating.

3. The system according to claim 1, wherein the data includes tire mileage.

4. The system according to claim 1, wherein the data includes G force to which the tire is exposed.

5. The system according to claim 1, wherein the data includes tire load relating to vehicle and cargo weight.

6. The system according to claim 1, wherein the output device includes an in-vehicle display.

7. The system according to claim 1, comprising a communications link in communication with the processor, the tire information residing in a device adapted to download the tire information to the communications link.

8. A method of monitoring treadwear comprising the steps of:
a) receiving data relating to a tire;
b) manipulating the data with an algorithm to determine a treadwear for the tire; and
c) outputting an indication of the treadwear to an output device.

9. The method according to claim 8, wherein the data includes tire information comprising at least one of a tire treadwear rating, a tire temperature rating and a tire traction rating.

10. The method according to claim 8, wherein the data includes tire mileage.

11. The method according to claim 8, wherein the data includes G force to which the tire is exposed.

12. The method according to claim 8, wherein the data includes tire load relating to vehicle and cargo weight.

13. The method according to claim 8, wherein the output device includes an in-vehicle display.

14. The method according to claim 8, wherein step a) includes communicating the data when installing the tire onto the vehicle.
